(19) United States
(12) Patent Application Publication
(10) Pub. No.: US 2025/0312727 A1
(43) Pub. Date: Oct. 9, 2025

(54) SEPARATION METHOD

(71) Applicant: L'Air Liquide, Societe Anonyme pour l'Etude et l’Exploitation des Procedes Georges Claude, Paris (FR)

(72) Inventors: Apolline LECOURT, Jouy-En-Josas (FR); Etienne RIGON, Jouy-En-Josas (FR); Christian MONEREAU, Champigny Sur Marne (FR)

(21) Appl. No.: 18/866,374

(22) PCT Filed: May 11, 2023
(86) PCT No.: PCT/EP2023/062558

§ 371 Date: Nov. 15, 2024

(30) Foreign Application Priority Data
May 16, 2022 (FR) FR2204606

(51) Int. Cl. B01D 53/047; B01D 53/04

(52) U.S. Cl. CPC B01D 53/047; B01D 53/0454; B01D 2257/502; B01D 2257/504; B01D 2257/7025; B01D 2258/0283

(57) ABSTRACT

A method for separating a feedstock gas by pressure swing adsorption which produces a first gaseous fraction enriched in a first component and a second gaseous fraction enriched in a second component, the separation unit comprising a plurality of adsorbers, the pressure cycle comprising a plurality of steps including at least one adsorption step and at least one rinsing step in which a rinsing fluid enriched in a first component flows through at least one adsorber so as to flush at least some of the second component out of the adsorber, the pressure cycle having a phase time corresponding to the duration of the pressure cycle divided by the number of adsorbers.

### CROSS-REFERENCE TO RELATED APPLICATIONS

This application is a § 371 of International PCT Application PCT/EP2023/062558, filed May 11, 2023, which claims § 119(a) foreign priority to French patent application FR 2204606, filed May 16, 2022.

### BACKGROUND

The present invention concerns a unit for separating by adsorption a gas supplied to said unit, known as the feedstock gas or gas to be processed, for production of a first fraction of feedstock gas enriched in highly adsorbable compounds and of a second fraction of feedstock gas enriched in poorly adsorbable compounds. The invention also concerns a method of separation by adsorption.

### FIELD OF THE INVENTION

Adsorption is widely used to purify or separate (fractionate) gases. Instances include the fractionation of “n” and “iso” paraffins, fractionation of xylenes, of alcohols, production of nitrogen or oxygen from atmospheric air, and removal of CO2 from flue gases and from blast furnace gases. On the purification side, there are dryers, hydrogen or helium purging, methane-rich gas purging, adsorption of trace impurities in numerous fluids (stopping mercury, NOx, sulfur products, etc.).

A gas supplied to the separation unit comprises a mixture of poorly adsorbable compounds and highly adsorbable compounds. In a method of separation by adsorption, firstly one or more highly adsorbable gaseous compounds (referred to below as the first component or highly adsorbable component), and secondly one or more poorly adsorbable compounds (referred to below as the second component or poorly adsorbable component) must be extracted from the feedstock gas. The supply gas therefore comprises a mixture of the two components. The highly adsorbable component is the more adsorbable component of said two components, and the poorly adsorbable component is the less adsorbable component of the two components. Depending on application, the usable gas (useful component) is either the poorly adsorbable component or in contrast the highly adsorbable component.

This is then referred to as the “product”. The other component constitutes the residue or “purge” (residual component).

In particular, a unit of separation by adsorption comprises multiple reservoirs for circulation of process gases, each reservoir containing an adsorbent material. These reservoirs, sometimes also known as columns, serve to support the adsorbent material and ensure circulation of the gases. These reservoirs are referred to below as “adsorbers”.

### Related Art

The methods involving adsorption are of several types according to whether or not the adsorbent can be regenerated in situ. Adsorption is said to be of the “spent charge” type, meaning that the charge needs to be renewed when the adsorbent becomes saturated with impurities (the term “backup bed” is also used in this case to qualify such purification) or in the other case the term “adsorption cycles” is used.

The adsorption cycles differ firstly in the way in which the adsorbent is regenerated. If the regeneration is performed essentially by increasing the temperature, then the method is a temperature swing adsorption (TSA) process. If, on the other hand, the regeneration is performed through a drop in pressure, then it is a pressure swing adsorption (PSA) process and the term PSA unit is used for pressure swing adsorption separation units.

Generally, the term PSA denotes any process for the purification or separation of gas employing a cyclical variation in the pressure which the adsorbent experiences between a high pressure, referred to as adsorption pressure, and a low pressure (lower than the high pressure), referred to as regeneration pressure. This is then called a purge process or pressure swing adsorption separation process. Thus, this generic designation of PSA (pressure swing adsorption) is employed without distinction to denote the following cyclical processes, to which it is also commonplace to give more specific names, depending on the pressure levels employed or the time necessary for an adsorber to return to its starting point (cycle time):
VSA processes, in which the adsorption is carried out substantially at atmospheric pressure, preferably between 0.95 and 1.25 bar abs, and the desorption pressure is lower than atmospheric pressure, typically from 50 to 400 mbar abs;
MPSA or VPSA processes, in which the adsorption is carried out at a high pressure greater than atmospheric pressure, typically between 1.35 and 6 bar abs, and the desorption is carried out at a low pressure lower than atmospheric pressure, generally of between 200 and 650 mbar abs;
PSA processes proper, in which the high pressure is substantially greater than atmospheric pressure, typically between 3 and 50 bar abs, and the low pressure is substantially equal to or greater than atmospheric pressure, generally between 1 and 9 bar abs;
RPSA (Rapid PSA) processes, for which the duration of the pressure cycle is typically less than a minute;
URPSA (Ultra Rapid PSA) processes, for which the duration of the pressure cycle is of the order of a maximum of a few seconds.

It should be noted that these various designations are not standardized and that, in particular, the indicated limits are subject to variation. Once again, unless otherwise stated, the use of the term PSA here covers all of these variants.

An adsorber will begin a period of adsorption until it is loaded with the constituent or constituents to be captured at the high pressure and will then be regenerated by depressurization and extraction of the adsorbed compounds, before being restored in order to again begin a new adsorption period. The adsorber has then completed a pressure cycle and the very principle of the PSA process is to link these cycles together one after the other. It is thus a cyclical process. In principle, each adsorber follows the same cycle with a time shift, which is known as phase time or more simply phase.

The following relationship thus exists:
phase time=(cycle time)/(number of adsorbers)

Each adsorber passes successively through the series of phases constituting the PSA cycle, each phase being of equal duration.

Conventionally, an adsorber is subjected to the pressure cycle comprising the following steps, in particular in the following order:
1) adsorption at the high pressure of the cycle with production of the second fraction enriched in poorly adsorbable component, in particular with supply of a re-pressurization flow comprising a part of the second fraction produced;
2) depressurization to the low pressure with production of the first fraction;
3) re-pressurization to the high pressure, in particular with re-pressurization flow supplied in step 1.

It is noted that in a cycle, a given step is distinguished from the preceding or following step in particular for one of the following reasons: the presence or absence of inlet and/or outlet flow and their direction of circulation in the adsorber, the origin of an incoming flow, the destination of an outgoing flow. A phase may comprise multiple separate steps, and conversely a step may persist over more than one phase.

An adsorption separation unit works with an extraction yield of the highly adsorbable component corresponding to the ratio of the quantity of highly adsorbable component in the first fraction extracted at low pressure over the quantity of highly adsorbable component in the feedstock gas. The separation unit also works with an extraction yield of the poorly adsorbable component corresponding to the ratio of the quantity of poorly adsorbable component in the second fraction extracted at high pressure over the quantity of poorly adsorbable component in the feedstock gas. Depending on application, we use the terms “product extraction yield” for the extraction yield of usable component, and “purge rate” for the extraction yield of residual component. More particularly, the invention concerns methods for separation by adsorption in which these extraction yields are not particularly high either for the product or for the purge.

A standard separation unit comprising a given adsorbent charge and/or given dimensions operates, for a fixed supply gas, along a characteristic curve “extraction yield of highly adsorbable component” versus “extraction yield of poorly adsorbable component”, or vice versa. FIG. 1 shows an exemplary curve (c), here with “extraction yield of highly adsorbable component” on the ordinate and “extraction yield of poorly adsorbable component” on the abscissa. Arbitrarily, the highly adsorbable component (first fraction) has been selected as the yield product R, and hence the poorly adsorbable component (second fraction) as the yield purge P. Very generally, the phase time is used as an adjustment means for following this curve. It is found that with a short phase time Tp1, it is practically impossible for the highly adsorbable component to penetrate into the second fraction at the high pressure. The highly adsorbable component therefore constitutes a very great majority in the first fraction extracted at low pressure, leading to a high extraction yield R1 of the more adsorbable component. The other consequence is that a large part of the poorly adsorbable component is left in the adsorber, wherein at least part of this component is extracted at low pressure, and the extraction yield of the poorly adsorbable component P1 is reduced accordingly. Conversely, a longer phase time Tp2 leads to corresponding yields R2 lower than R1, and P2 greater than P1.

In general, the main constraint for the product is to observe the specified purity (for example, to produce hydrogen at 99.99% mole), and the separation unit is adjusted to operate with the best yield possible, which allows limitation of the necessary supply gas flow and hence of the cost of raw materials (natural gas in this example).

In certain industrial applications however, it is necessary to observe precise specifications for both fractions produced by PSA units, even in the case of a change in composition of the supply gas. For other applications, in which in contrast the supply remains unchanged, it is the specifications of the products which must change over time. A topical example illustrating the latter case is the imposed increase in the CO2 capture rate in coming years for environmental reasons.

A so-called rinsing step may be added to the cycle, comprising circulation in an adsorber of a gas enriched in the highly adsorbable component, called rinsing fluid, with the aim of expelling the gases of the poorly adsorbable component from the adsorbent material and dead volumes. Such a step may increase the extraction yield of poorly adsorbable component by recovering part of the poorly adsorbable gaseous compounds present in the adsorber at the end of the adsorption step. It is also possible to add such a rinsing step when the highly adsorbable component is the useful component, so as to limit the quantity of poorly adsorbable component therein.

It is known from the prior art to use such a rinsing step to produce a fraction enriched in poorly adsorbable gaseous compounds with a high purity and yield. This is the case in particular when the object is to produce methane for injection into a so-called natural gas network with a required methane purity often greater than 96% and with an extraction yield of the order of 95% or more. To achieve a high yield and purity, the rinsing fluid flow rate may be higher than the production flow rate, leading to significant over-dimensioning in terms of adsorbent volume and compression means. This has great effects on the price of construction of the installation and on the operating cost of this installation because of a higher energy consumption. Thus the installations known from the prior art are mainly found on discharge gases and economically can only be justified by environmental reasons (prohibition on emission of high quantities of greenhouse gases) and corresponding subsidies. The installations known from the prior art operating a rinsing step are therefore not competitive. Furthermore, an increase in the rinsing fluid flow rate to achieve a high extraction yield of poorly adsorbable component leads to a reduction in the extraction yield of highly adsorbable component because of the characteristic curve (limit curve) of operation of the unit.

These standard separation units, with or without rinsing step, evidently do not meet requirements if the aim is to go beyond these limit curves, for example by increasing the product extraction yield while maintaining the purge rate, or by increasing the purge rate while maintaining the product extraction yield. There is therefore a need for an adsorption separation unit with increased operational flexibility.

### SUMMARY OF THE INVENTION

The object of the invention is thus a method for separating a feedstock gas by pressure swing adsorption, wherein a separation unit is supplied with the feedstock gas and produces a first gaseous fraction enriched in a first component and a second gaseous fraction enriched in a second component, the first component being more adsorbable than the second component. The separation unit comprises a plurality of adsorbers, said adsorbers being subjected to a pressure cycle featuring a high pressure and a low pressure. The pressure cycle comprises a plurality of steps including at least one adsorption step and at least one rinsing step. During the rinsing step, a rinsing fluid enriched in the first component circulates through at least one adsorber so as to expel at least a part of the second component from said adsorber. The pressure cycle has a phase time corresponding to a duration of the pressure cycle divided by the number of adsorbers. The method comprises the following steps:
a) determination of a first component extraction yield value defined by the ratio of the quantity of first component in the first fraction produced over the quantity of first component in the feedstock gas supplied to the separation unit,
b) determination of a second component extraction yield value defined by the ratio of the quantity of second component in the second fraction produced over the quantity of second component in the feedstock gas supplied to the separation unit,
c) determination of a first difference between the first component extraction yield value determined in step a) and a first reference value relating to the first component extraction yield, and of a second difference between the second component extraction yield value determined in step b) and a second reference value relating to the second component extraction yield,
d) if the first difference is greater than a first predetermined threshold and/or the second difference is greater than a second predetermined threshold, modification of the phase time and modification of a flow rate of the rinsing fluid, called the rinsing flow rate, so as to reduce the first difference and/or the second difference.

Acting on the phase time parameter and on the rinsing flow rate parameter allows compensation for the increase or reduction in extraction yield caused by modification of one or the other of these parameters. For example, to increase the first component extraction yield while maintaining the second component extraction yield, the phase time duration may be shortened and the rinsing flow rate value increased. Controlling the two parameters, rinsing flow rate and phase time, therefore allows greater operating flexibility for the extraction yields of the first component and second component, compared with the separation units of the prior art.

The first threshold and the second threshold may in particular be defined to take account of normal fluctuations in yield of the separation method.

According to an embodiment of the method, the phase time and rinsing flow rate are modified such that the first difference is made less than or equal to the first threshold, and/or the second difference is made less than or equal to the second threshold.

According to an embodiment of the method, the unit works in a plurality of operating modes, the rinsing fluid circulating at a determined rinsing flow rate value and the phase time being defined according to a determined phase time duration in each of the operating modes.

According to an embodiment of the method, the rinsing flow rate and the phase time are modified jointly. In particular, the rinsing flow rate and the phase time are modified simultaneously.

The rinsing flow rate and the phase time are in particular modified independently of one another.

According to an embodiment of the method, the rinsing flow rate is increased and the phase time shortened so as to increase the determined first component extraction yield and maintain the determined second component extraction yield. This improves the separation between the first component and the second component.

According to an embodiment of the method, the phase time and rinsing flow rate are modified such that the determined first component extraction yield reaches the first reference value, and/or the determined second component extraction yield reaches the second reference value.

According to an embodiment of the method, the first threshold and/or the second threshold is equal to 3%, preferably equal to 1.5%, preferably equal to 0.5%, and possibly equal to zero. In the latter case, in the case of a difference between the determined first component extraction yield value and the first reference value, and/or a difference between the determined second component extraction yield value and the second reference value, the phase time and the rinsing flow rate are modified such that the determined first component extraction yield reaches the first reference value, and/or the determined second component extraction yield reaches the second reference value. This gives a yield percentage relative to the scale 0-100%. Thus for a yield reference value of for example 65%, the various yield ranges beyond which the method would be implemented would be as follows for the threshold of 3%: 62/68%; for the threshold of 1.5%: 63.5/66.5%; for the threshold of 0.5%: 64.5-65.5%. The choice of one of these ranges will depend on the sensitivity of downstream units to the separation performance of the separation unit, and the measurement accuracy for the yield of the separation units.

According to an embodiment of the method, the first component extraction yield value and the second component extraction yield value are determined by analysis of the composition of the feedstock gas supplied to the unit, the first fraction produced and the second fraction produced. In particular, an analyzer determines the content of first component and/or second component in the feedstock gas, the first fraction and the second fraction. The content of first and/or second component is measured for example using one or more sensors. The analyzer may in particular deduce the content of first component or second component from the measured content of the other component. The flow rates of the feedstock gas, the first fraction and the second fraction may be taken into account in determination of the yield values.

According to an embodiment of the method, the first reference value expressed as a yield percentage lies between 25 and 90% and the second reference value expressed as a yield percentage lies between 20 and 90%.

According to an embodiment of the method, the rinsing step immediately follows an adsorption step.

According to an embodiment of the method, the pressure cycle comprises at least the following steps, in particular in the following order:
1) adsorption at the high pressure of the cycle with production of the second fraction enriched in the second component, in particular with supply of a re-pressurization flow comprising a part of the second fraction produced;
2) rinsing;
3) depressurization to the low pressure with production of the first fraction and supply of the rinsing flow;
4) re-pressurization to the high pressure, in particular with re-pressurization flow supplied in step 1.

According to an embodiment of the method, the pressure cycle comprises the following steps, in particular in the following order:
1) adsorption at the high pressure of the cycle with production of the second fraction enriched in the second component, in particular with supply of a re-pressurization flow comprising a part of the second fraction produced;
2) rinsing;
3) at least one balancing step with falling pressure and supply of one or more balancing flows with rising pressure;
4) supply of elution gas;
5) depressurization to the low pressure with production of the first fraction;
6) elution with the elution gas supplied in step 4, production of the first fraction and supply of the rinsing flow over at least one of steps 5 and 6;
7) at least one balancing step with rising pressure with the balancing flow or flows supplied in step 3;
8) re-pressurization to the high pressure, in particular with re-pressurization flow supplied in step 1.

A pressure cycle comprising the preceding steps 1 to 8, but without the balancing steps with rising and falling pressure (steps 3 and 7) may also be implemented as an intermediate cycle between the above-described cycles.

According to an embodiment of the method, after a step of depressurization to a pressure close to atmospheric pressure, the pressure cycle comprises a step of vacuum pumping, during which the first fraction is evacuated. The elution step may coincide with the vacuum pumping step or may correspond to a final part of the vacuum pumping step. The low pressure of the cycle may then be reached during the vacuum pumping step or at the end of said step, depending on flow rates.

According to an embodiment of the method, the pressure cycle also comprises one or more dead time steps during which one or more adsorbers remain in the same state. In particular, the adsorbers remain at the same pressure in the dead time step.

According to an embodiment of the method, a part of the first fraction is used as product gas and another part is utilized as rinsing fluid.

According to an embodiment of the method, the rinsing flow rate divided by the sum of the rinsing flow rate and a flow rate of said product gas lies between 0.05 and 0.65, preferably between 0.05 and 0.5.

According to an embodiment of the method, the product gas flow is compressed before being directed towards downstream equipment.

According to an embodiment of the method, the rinsing fluid is also compressed before being introduced into the adsorber undergoing the rinsing step. In particular, the rinsing fluid is compressed up to the high pressure.

According to an embodiment of the method, the rinsing fluid circulates through the at least one adsorber undergoing the rinsing step in the same circulation direction as the feedstock gas when said adsorber undergoes the adsorption step. The rinsing step is then described as co-current.

According to an embodiment of the method, a flow originating from the adsorber undergoing the rinsing step is introduced together with the feedstock gas into at least one adsorber undergoing the adsorption step.

According to an embodiment of the method, the rinsing step is performed over an integral number of phase times. The rinsing step is then performed over at least one complete phase time.

According to an embodiment of the method, the phase time is modified by controlling at least one parameter of a gas flow supplied to an adsorber of the separation unit and/or at least one parameter of a gas flow produced by an adsorber of the separation unit, in particular at least one parameter of a gas flow transferred from one adsorber to another.

In particular, said parameter is selected from the flow rate and/or flow duration.

According to an embodiment of the method, the phase time is modified via at least one of the following actions:
addition or elimination of a step in the pressure cycle;
lengthening or shortening of a step.

According to an embodiment of the method, a dead time step, during which one or more adsorbers remain in the same state as at the end of the preceding step, is added to the pressure cycle. In particular, the dead time step is added by fluidically isolating the or said adsorbers remaining in the same state.

According to an embodiment of the method, a dead time step is lengthened or shortened.

According to an embodiment of the method, the phase time is modified at the phase start.

According to an embodiment of the method, the phase time is modified by shifting in time a start and/or an end of supply of the gas flow to at least one adsorber.

According to an embodiment of the method, the phase time is modified by shifting in time a start and/or an end of production of the gas flow by at least one adsorber.

According to an embodiment of the method, the phase time is modified by shifting in time a start and/or an end of supply of the feedstock gas to one or more adsorbers in the adsorption step, and/or by shifting in time a start and/or an end of production of the second fraction by the or said adsorbers.

According to an embodiment of the method, a flow rate of a gas flow transferred from one adsorber to another is adjusted so as to accelerate or decelerate a gas transfer between said adsorbers.

In particular, the adsorber supplying the gas flow is in depressurization and the adsorber receiving the gas flow is in pressurization, and the gas transfer is accelerated or decelerated so as to increase or reduce a speed of depressurization and/or pressurization of said adsorbers. In particular, the transfer flow is a balancing flow between at least one adsorber in the balancing step with falling pressure and at least one adsorber in the balancing step with rising pressure.

According to an embodiment, the method comprises the following steps:
i) recording in a database points of stabilized operation of the separation unit, the operating points corresponding to pairs of phase time duration and rinsing flow rate value, each pair being associated with a first component extraction yield value and a second component extraction yield value of the separation unit,
ii) if the first difference is greater than the first threshold and/or the second difference is greater than the second threshold, reading from the database a phase time duration and a rinsing flow rate value allowing the first difference to be made less than or equal to the first threshold and/or the second difference to be made less than or equal to the second threshold, then modification of the phase time into the phase time duration read from the database and modification of the rinsing flow rate into the rinsing flow rate value read from the database.

According to an embodiment of the method, steps a), b), c) and d) as defined above are repeated until the first difference is less than or equal to the first threshold and/or the second difference is less than or equal to the second threshold, with, for step d), a modification of the last phase time duration into a new phase time duration and a modification of the last rinsing flow rate value into a new rinsing flow rate value.

According to an embodiment of the method, the modification of the phase time and rinsing fluid flow is implemented in a first time by iterations via the duration of the phase time with a constant rinsing flow rate value, then in a second time by iterations via the rinsing flow rate value with a constant phase time duration. Such a sequence may in particular be repeated.

According to an embodiment of the method, the modification of the phase time and rinsing fluid flow is implemented in a first time by iterations via the rinsing flow rate value with a constant phase time duration, then in a second time by iterations via the duration of the phase time with a constant rinsing flow rate value. Such a sequence may also be repeated.

According to an embodiment of the method, steps a), b), c) and d) are repeated in addition to modification of the phase time and rinsing flow rate by reading from a database, in particular after this modification by reading from a database.

According to an embodiment of the method, steps a), b), c) and d) are repeated as an alternative to modification of the phase time and rinsing flow rate by reading from a database.

According to an embodiment of the method, a useful component similar to a product and a residual component similar to a purge are extracted. In particular, the first component is the useful component and the second component is the residual component.

The method may be used for capturing carbon monoxide, in particular from the fumes of a blast furnace, in order to recycle it as a reducing agent into said blast furnace, wherein the feedstock gas comprises a mixture of carbon monoxide and nitrogen, the first fraction being enriched in carbon monoxide and the second fraction being enriched in nitrogen, carbon monoxide constituting the first component and nitrogen constituting the second component.

The fumes are for example firstly treated in a carbon dioxide capture unit.

The method may be used for capturing carbon dioxide, wherein the feedstock gas comprises a mixture of carbon dioxide and nitrogen, the first fraction being enriched in carbon dioxide, the second fraction being enriched in nitrogen, carbon dioxide constituting the first component and nitrogen constituting the second component.

The method may be used for purifying a feedstock gas comprising a mixture of methane and nitrogen. According to this embodiment, the first fraction is enriched in methane, the second fraction is enriched in nitrogen, methane constituting the first component and nitrogen constituting the second component.

The invention also concerns a unit for separating a feedstock gas by pressure swing adsorption for production of a first gaseous fraction enriched in a first component and production of a second gaseous fraction enriched in a second component, the first component being more adsorbable than the second component. The separation unit comprises a plurality of adsorbers configured to be subjected to a pressure cycle featuring a high pressure and a low pressure. The pressure cycle comprises a plurality of steps including at least one adsorption step and a rinsing step. During the rinsing step, a rinsing fluid enriched in the first component circulates through at least one adsorber so as to expel at least a part of the second component from said adsorber. The pressure cycle has a phase time corresponding to the duration of the pressure cycle divided by the number of adsorbers. The separation unit comprises:
a flow control system configured to modify the phase time, in particular by controlling at least one parameter of a gas flow supplied to an adsorber of the separation unit and/or at least one parameter of a gas flow produced by an adsorber of the separation unit, in particular at least one parameter of a gas flow transferred from one adsorber to another,
a flow adjustment device configured to modify a rinsing fluid flow rate,
a control unit and communication means between the control unit, the flow control system and the flow adjustment device, the control unit being configured to implement the method as described above.

According to an embodiment, the flow control system is configured to modify the phase time by:
adding a step to the pressure cycle or eliminating a step from the pressure cycle;
lengthening or shortening a step.

According to an embodiment, the flow control system comprises at least one supply valve configured to allow or prevent the supply of feedstock gas to one or more adsorbers in the adsorption step.

In addition or alternatively, the flow control system comprises at least one production valve configured to allow or prevent production of the second fraction enriched in the second component by one or more adsorbers in the adsorption step, in particular the or said adsorbers in the adsorption step.

According to an embodiment, the flow control system comprises at least one transfer valve configured to adjust the transfer flow rate between at least one adsorber supplying the transfer flow and an adsorber receiving the transfer flow.

The supply valve and/or the production valve may be a shut-off valve. The transfer valve is for example a proportional valve.

According to an embodiment, the separation unit comprises a divergence member configured to divide the flow of the first fraction into the production flow and the rinsing fluid flow. In particular, the divergence member comprises a circulation channel for the first gaseous fraction produced, a channel from which a rinsing fluid circulation channel and a production flow circulation channel diverge. The divergence member then for example has a T-shape. According to an example, the divergence member comprises a three-way valve.

According to an embodiment, the separation unit comprises a compression means, for example a compressor, configured to compress the rinsing fluid, in particular up to the high pressure, before introduction into the adsorber undergoing the rinsing step. In an embodiment of the method which is not shown, the compressor is also configured to compress the product gas flow, in particular to a pressure required for provision to downstream equipment.

According to an embodiment, the flow adjustment device comprises at least one valve, such as a two-way valve, or two two-way valves. In particular, these may be proportional valves. In particular, the flow adjustment device comprises the three-way valve. Alternatively or additionally, the flow adjustment device comprises the compressor.

According to one embodiment, the separation unit comprises at least one vacuum pump configured to facilitate desorption of the first component. Desorption then takes place at a low pressure which is lower than atmospheric pressure.

According to an embodiment, the control unit comprises data reconciliation software allowing determination, from redundant measures, of the most probable value of the determined extraction yields and their uncertainty.

### BRIEF DESCRIPTION OF THE FIGURES

FIG. 1 shows the characteristic curve of a separation unit according to the prior art in a graph showing product extraction yield versus purge rate;

FIG. 2 shows the operating area of a unit according to the invention in a graph of product extraction yield versus purge rate;

FIG. 3 shows a separation unit according to the invention comprising four adsorbers;

FIG. 4 shows a separation unit according to the invention comprising eight adsorbers;

FIG. 5 is a block diagram illustrating the steps of the separation method according to the invention and adjustment of the unit by iterations;

FIG. 6 shows curves determined by simulation for determining operating points of the separation unit for an adjustment by reading from a database;

FIG. 7 shows an example of adjustment by iterations.

### DETAILED DESCRIPTION OF THE INVENTION

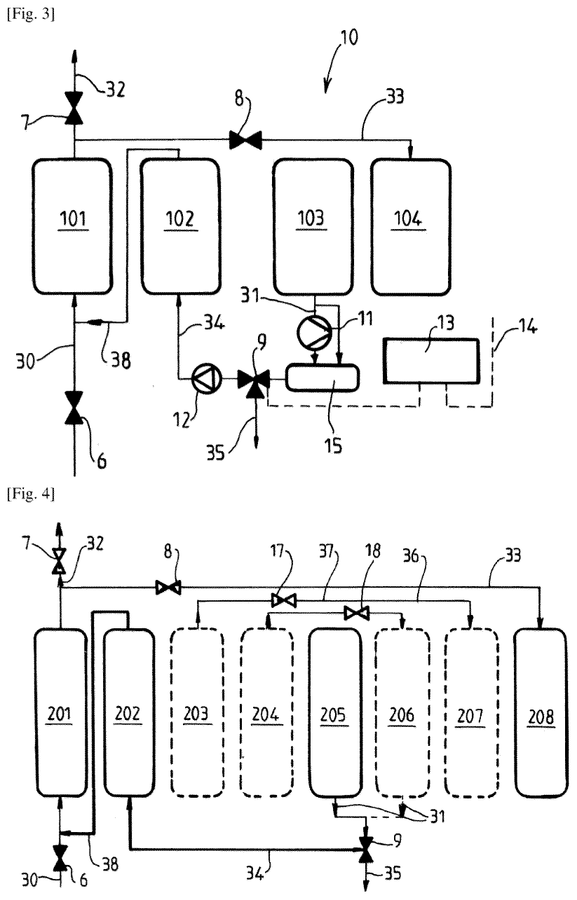

A separation unit 10 implementing the method according to the invention is shown in FIG. 3. In this embodiment, the unit comprises four adsorbers implementing the steps 101, 102, 103 and 104 which will be detailed below.

The unit 10 comprises a flow control system which comprises a supply valve 6 able to allow or prevent supply of feedstock gas 30 to an adsorber in the adsorption step 101, a production valve 7 able to allow or prevent the production of the second fraction 32 by the adsorbers in the adsorption step 101. The supply valve 6 and production valve 7 are here shut-off valves which allow or prevent a supply of feedstock gas 30 or production of the second fraction 32 respectively. Such shut-off valves may therefore selectively allow or prevent circulation of a corresponding gas flow. The flow control system comprises a transfer valve, here a proportional pressurization valve 8 which allows adjustment of a so-called transfer flow corresponding to a gas transfer between two adsorbers. This transfer flow, in this embodiment, is a pressurization flow 33 originating from the second fraction 32, between the adsorber producing the second fraction 32 in step 101 and the adsorber in pressurization or re-pressurization in step 104. Such a valve can progressively adjust a corresponding gas flow.

Also, a flow adjustment device, which here comprises a three-way valve 9 and a compressor 12, allows modification of a rinsing fluid flow rate (called the “rinsing flow 34”) during a rinsing step 102; 202 which will be described in more detail below. The compressor 12 also allows compression of the rinsing flow 34, for example up to the high pressure of the pressure cycle, before introduction into the adsorber undergoing the rinsing step 102. The three-way valve 9 thus also serves as a T-shaped divergence member for dividing the flow of the first fraction produced in step 103 into a useful product gas flow 35, which is for example sent to a following step of an installation comprising the separation unit, and the rinsing flow 34. This product gas flow is for example compressed before being sent to downstream equipment. A buffer reservoir 15 allows limitation of fluctuations of pressure and composition and also facilitates control of the compressor 12.

The separation unit also comprises a vacuum pump 11 which facilitates desorption of the first component in step 103, at a pressure below atmospheric pressure. A low pressure of the cycle is reached during step 103.

The separation unit 10 comprises a control unit 13 and communication means 14 between the control unit 13, the flow control system and the flow adjustment device. The control unit 13 is able to implement the separation method according to the invention. In particular, the control unit 13 comprises programmable electronics, programmed to implement the method according to the invention.

In the method according to the invention, the separation unit 10 is supplied with a feedstock gas 30 which comprises a mixture of firstly one or more poorly adsorbable compounds and secondly one or more highly adsorbable compounds. The separation unit 10 extracts the highly adsorbable compound or compounds, which constitute a first highly adsorbable component, from the feedstock gas 30. The separation unit 10 also extracts the poorly adsorbable compound or compounds, which constitute a second poorly adsorbable component, from the feedstock gas 30. A “highly adsorbable component” is the most adsorbable component of said two components, and a “poorly adsorbable component” is the least adsorbable component of said two components. In other words, the first component is more adsorbable than the second. The separation unit 10 then produces a first gaseous fraction 31 enriched in a first component and a second gaseous fraction 32 enriched in a second component. In the applications described below, the useful component is the first component. This it is then referred to as the “product”. The second component then constitutes the residue or purge. In certain applications, the second component comprises the poorly adsorbable component which is predominant, such as nitrogen, or the second component equates to this predominantly poorly adsorbable component. The second component may however also comprise compounds such as argon, oxygen or hydrogen, in particular when these are in the minority.

In the implementation of the method according to FIG. 3, the adsorbers of the unit are subjected to a pressure cycle comprising the following steps in the following order:
Step 101: adsorption at the high pressure of the cycle with production of the second fraction 32 enriched in the second component, and extraction from the produced second fraction 32 of a pressurization or re-pressurization flow for the adsorber in step 104. The pressurization flow 33 is regulated by the pressurization valve 8.
Step 102: co-current rinsing.
Step 103: depressurization to the low pressure with production of the first fraction 31 and supply of the rinsing flow 34 for the adsorber in step 102.
Step 104: re-pressurization to the high pressure with the re-pressurization flow 33 supplied by the adsorber 101.

The phase time is therefore equal to the duration of the pressure cycle, or cycle time, divided by the number of adsorbers, here four adsorbers.

In a second implementation of the method shown in FIG. 4, the separation unit 10 comprises eight adsorbers. For reasons of simplicity, in comparison with the embodiment in FIG. 3, only the differences concerning the number and nature of the steps of the pressure cycle, the gas flows and the valves are shown. The other elements of the unit may be implemented in equivalent fashion in this second embodiment.

The unit comprises a flow control system which comprises three transfer valves, a pressurization valve 8, a balancing valve 17 and an elution gas supply valve 18. These transfer valves are valves for adjusting a gas transfer flow between two adsorbers. These transfer valves are here proportional valves.

The adsorbers of the unit are subjected to a pressure cycle comprising the following steps in the following order:
Step 201: adsorption at the high pressure of the cycle with production of the second fraction 32 enriched in the second component, and extraction from the second fraction 32 produced of a pressurization or re-pressurization flow 33 for the adsorber in step 208. The pressurization or re-pressurization flow 33 is adjusted by the pressurization valve 8.
Step 202: co-current rinsing. The flow adjustment device is then at least partially open to allow circulation of the rinsing fluid.
Step 203: balancing with falling pressure and supply of a balancing flow 36 to balance the adsorber in step 207 with rising pressure. The balancing flow 36 is adjusted by the balancing valve 17.
Step 204: supply of elution gas for elution of the adsorber in step 206. The elution gas flow 37 is adjusted by the elution gas supply valve 18.
Step 205: depressurization to the low pressure with production of the first fraction 31 and supply of the rinsing flow 34 for the adsorber in step 202.
Step 206: elution with the elution gas supplied in step 4, production of the first fraction 31 and supply of the rinsing flow 34 to the adsorber in step 202.
Step 207: balancing with rising pressure with the balancing flow 36 supplied by the adsorber in step 203.
Step 208: re-pressurization to the high pressure with the re-pressurization flow 33 supplied by the adsorber in step 201.

In both these implementations, the rinsing step 102; 202 immediately follows the adsorption step 101; 201. In other words, an adsorber which has undergone the adsorption step 101; 201, once said adsorption step 101; 201 is finished, undergoes as the next step a rinsing step 102; 202, with no intermediate step between the adsorption step 101; 201 and the rinsing step 102; 202.

The phase time is therefore equal to the duration of the pressure cycle, or cycle time, divided by the number of adsorbers, here eight adsorbers.

In other embodiments, the pressure cycle comprises multiple balancing steps with rising pressure and multiple balancing steps with falling pressure. These may be successive balancing steps or balancings, wherein the gas flow rates or quantities may vary from one balancing step to the next.

According to an embodiment not shown, the pressure cycle may also comprise one or more dead time steps, during which one or more adsorbers remain in the same state as at the end of the preceding step, for example at the same pressure. The objective may be for example to synchronize the other steps between the adsorbers.

The description which follows applies to both the embodiment of FIG. 3 and that of FIG. 4.

During the rinsing step 102; 202, a so-called rinsing fluid enriched in the first component circulates through at least one adsorber, sweeping from one end to the other, so as to expel at least a part of the second component from the adsorber. A flow originating from the adsorber in the rinsing step 102; 202 is injected with the feedstock gas 30 in step 101; 201 into the adsorber undergoing the adsorption step. This recycling of the flow from the adsorber undergoing the rinsing step (so-called recycled gas flow 38) allows an increase in yield of the first component. A “flow enriched in the first component” means that the first component is the quantitatively predominant component of the first and second components.

It is possible to define a rinsing ratio RR according to the equation:

$$RR = \frac{Qr}{( Qp + Qr )} \qquad [ Math 1 ]$$

wherein Qr is the rinsing flow rate and Qp a product gas flow rate. Typically, the value of the rinsing ratio RR is between 0.05 and 0.65, preferably between 0.05 and 0.5.

The three-way valve 9 and the compressor 12 of the flow adjustment device allow modification of the rinsing flow 34 and hence the rinsing ratio RR.

The rinsing step 102; 202 may be carried out over an integral number of phase times, i.e. at least over one complete phase time, which gives a continuous and constant rinsing flow 34 and hence recycled gas flow 38.

In the context of the method according to the invention, the separation unit 10 may therefore operate in a plurality of operating modes 1; 2; 3; 4 (see FIG. 2). In each of said operating modes, the rinsing fluid circulates at a determined rinsing flow rate value 34 and the phase time is defined according to a determined phase time duration.

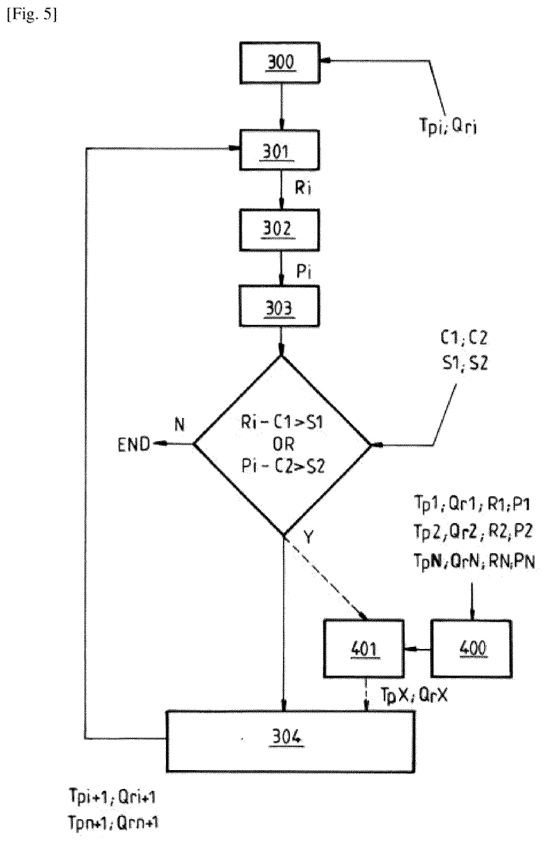

In an initial state shown in FIG. 5 in step 300, the unit operates in a first mode in which the rinsing fluid circulates with a first rinsing flow rate value Qri and in which the phase time is equal to a first duration Tpi. In particular, this may be a first nominal operating mode of the separation unit 10 after start-up.

FIG. 5 also shows the steps 301 to 304 of the separation process:

In step 301, a yield value of the separation unit 10 for extraction of the first component of the feedstock gas 30 is determined. This first component extraction yield corresponds to the ratio of the quantity of first component in the first fraction 31 produced by the separation unit 10 over the quantity of first component in the feedstock gas 30 supplied to the unit. In particular, the first component extraction yield corresponds to the content of first component in the first fraction 31 over the content of first component in the feedstock gas 30. This yield is determined for example by analysis of the composition of the feedstock gas 30 supplied to the unit and of the first fraction 31 produced. In particular, an analyzer determines the content of first component in the feedstock gas 30 and in the first fraction 31. The content of first component is measured for example using one or more sensors. It is thus a mass ratio. Since the first component is here the useful component, the first component extraction yield is called the “product yield” for the yield of useful component or product. In the initial state, the separation unit 10 thus operates with a product yield value Ri.

The instrumentation comprising the analyzers, flow meters, pressure and temperature sensors, is not shown in FIGS. 3 and 4.

In a step 302, a yield value of the separation unit 10 for extraction of the second component from the feedstock gas 30 is determined. This second component extraction yield corresponds to the ratio of the quantity of second component in the second fraction 32 produced over the quantity of second component in the feedstock gas 30 supplied to the unit. In particular, the second component extraction yield value corresponds to the content of second component in the second fraction 32 over the content of second component in the feedstock gas 30. This yield is determined for example by analysis of the composition of the feedstock gas 30 supplied to the unit and of the second fraction 32 produced. In particular, the analyzer determines the content of second component in the feedstock gas 30 and in the second fraction 32. The content of second component is measured for example using one or more sensors. It is thus a mass ratio. As the first component is the useful component, the second component extraction yield is called the “purge rate”. In the initial state, the separation unit 10 operates with a purge rate Pi.

The analyzer may in particular deduce the content of first component or second component from the measured content of the other component. The flow rates of the feedstock gas 30, the first fraction 31 and the second fraction 32 may be taken into account in determination of the yield values. A data reconciliation software, for example integrated in the control unit 13, allows determination of the most probable values for the yields and the uncertainty of these values in the case of redundant data. Such software takes account of the uncertainties of all measurements used in determination of the parameter or parameters for which the value is required, and the necessary looping of assessments, here the material assessments, to maximize the probability of the result.

Steps 301 and 302 may be executed simultaneously. Step 301 may be also be executed before step 302, or step 302 before step 301.

The control unit receives, for example from an operator, a first reference value C1 for the product extraction yield and a second reference value C2 for the purge rate. In the case of a change in specifications of the composition of the first fraction 31 produced and/or the second fraction 32 produced, the product yield value Ri and the purge rate Pi must change. This may also occur if the flow rate of the feedstock gas 30 varies. The first reference value typically lies between 25 and 90%, and the second reference value between 20 and 90%. These are the yield percentages for operation of the separation unit. In contrast to the findings in the prior art when high extraction yields and purity levels were be achieved, it is found that use of a rinsing step is competitive as soon as the desired extraction yields are of the order of magnitude of those corresponding to standard separation units but with an increased flexibility between the product extraction yield and purge rate.

In step 303, a first difference is calculated between the product yield value Ri determined in step 301 and the first reference value C1 relating to the first component extraction yield. Similarly, a second difference is calculated between the purge rate Pi determined in step 302 and the second reference value C2 relating to the second component extraction yield.

A first threshold S1 and a second threshold S2 are predetermined and recorded in the control unit. The thresholds correspond to a permitted difference between the determined extraction yields (product yield and purge rate) and the reference values C1; C2 relating to these extraction yields. The selected thresholds may therefore be a function of the uncertainty of the permitted extraction yields. In other words, in this case there may be an agreed residual difference between the determined extraction yields (product yield and purge rate) and the reference values C1; C2, as long as these residual differences remain in absolute value below the corresponding threshold S1; S2.

The first difference is compared to the first threshold S1, and the second difference is compared to the second threshold S2. If the first difference is less than or equal to the first threshold S1, and the second difference less than or equal to the second threshold S2, the method is terminated.

If at least one of the first and second differences is greater in absolute value than the corresponding threshold S1 or S2, the method passes to step 304 which consists of modifying the first phase time duration Tpi into a second phase time duration Tpi+1 different from the first, and modifying the first rinsing flow rate value Qri into a second rinsing flow rate value Qri+1 different from the first, so as to reduce the first difference and/or reduce the second difference. In other words, both the phase time and the rinsing flow rate with which the unit operates in step 300 are modified simultaneously. The phase time duration may be lengthened or shortened, and the rinsing flow rate value increased or reduced. It is therefore possible that the first difference or the second difference, but also both, may exceed the corresponding threshold S1 or S2, which is sufficient to pass to step 304 of the method.

The phase time may be modified firstly and then the rinsing flow rate modified. Conversely, the rinsing flow rate may be modified firstly and then the phase time secondly. In order to reach the desired yield values more quickly, the rinsing flow rate and the phase time may be modified together. In particular, the rinsing flow rate and the phase time are modified simultaneously. Control of the separation method is then faster. In fact before making a new change, the operation of the separation unit should be allowed to stabilize, i.e. the measured yields should move towards their new value in a sufficiently asymptotic fashion to allow assessment of the remaining differences between measured and reference values. Such a stabilization will take several cycles, and simultaneous modification of the two parameters of phase time and rinsing flow rate will achieve stabilization more quickly than if this modification is performed in two successive steps, the second modification being performed only after initial stabilization of the separation unit 10.

The rinsing flow rate and the phase time are in particular modified independently of one another. In other words, the actuators 6; 7; 8; 9; 12; 17; 18 act on the two parameters of phase time and rinsing flow rate to change the value of each of the two parameters independently of modification of the value of the other parameter, in particular to modify each of these parameters beyond any modification induced by modification of the other parameter. In particular, the flow control system acts on the first parameter of phase time, in particular on the duration of the rinsing phase, and the flow adjustment device acts on the parameter of rinsing flow rate. In a particular implementation of the method, the rinsing flow rate is modified independently of the feedstock gas flow rate.

It is understood that the flow control system comprises all actuators allowing modification of the phase time (and thus changing of the cycle time of the separation unit 10) by one or more of the methods described below.

The separation unit 10 then operates with a new product yield and new purge rate. For example, the rinsing flow rate value 34 is increased and the phase time shortened so as to increase the determined first component extraction yield and maintain the determined second component extraction yield.

As the thresholds selected for the above-mentioned differences are a function of the uncertainty of the product yield R and purge rate P, modification only takes place if the measured difference between the measured yield and the reference yield is greater than or equal to the uncertainty of the yield. Also, this may allow the method to be stopped as soon as the difference between measured and reference values is equal to or less than the calculated uncertainty. In the absence of redundant data and reconciliation software, the process for triggering and/or stopping modification of the operating parameters may be equivalent, although the uncertainties will be greater and logically so will the difference thresholds.

To modify the phase time, in particular the adsorption phase time, the control unit 10 may for example send a control signal to the supply valve 6, ordering its full opening or full closure. One possible action is for example to shift in time a start of supply of feedstock gas 30 to the adsorber in the adsorption step 101; 201 at the phase start. Similarly, it is also possible to shift in time an end of supply of feedstock gas 30 to said adsorber.

In addition or alternatively, the control unit 10 may for example send a control signal to the production valve 7, ordering its full opening or full closure. One possible action is for example to shift in time a start of production of the second fraction 32 by the adsorber in the adsorption step 101; 201 at the phase start. Similarly, it is also possible to shift in time an end of production of the second fraction 32 by said adsorber.

Shifting the supply of gas flow to the adsorber in the adsorption step 101; 201 and/or production of a gas flow by this adsorber in this fashion equates to lengthening or shortening of said adsorption step 101; 201 in the embodiments of FIGS. 3 and 4.

Another additional or alternative solution for lengthening or shortening the pressure cycle duration, by acting on the duration of a cycle step, is to modify the phase or phases comprising the pressurization or re-pressurization step 104; 208, the steps of balancing with falling pressure 203 and balancing with rising pressure 207, and the steps of elution gas supply 204 and elution 206. In this case, the control unit 13 sends a control signal to one of the transfer valves 8; 17; 18 in order to adjust a so-called transfer flow 33; 36; 37 between one of the adsorbers supplying a gas flow in steps 101; 201; 203; 204 and one of the adsorbers receiving said corresponding gas flow in steps 104; 206; 207; 208. It is then possible, by adjusting the transfer flow, to increase or reduce the speed of pressurization, re-pressurization, balancing or elution of the adsorbers in steps 104; 206; 207 and 208. In the case of the adsorber in the re-pressurization or pressurization step 208, the transfer flow is a pressurization flow 33, and a transfer valve allowing the adjustment is the pressurization valve 8. In the case of the adsorbers in the balancing steps 203; 207, the transfer flow is a balancing flow 36, and a transfer valve allowing the adjustment is the balancing valve 17. In the case of the adsorbers in the steps of elution gas supply or elution 204; 206, the transfer flow is an elution gas supply flow 37, and a transfer valve allowing the adjustment is the elution gas supply valve 18. In the embodiments of FIGS. 3 and 4, this equates to lengthening or shortening the pressurization or re-pressurization step 104; 208, the steps of balancing with falling pressure 203 and balancing with rising pressure 207, and/or the steps of elution gas supply 204 and elution 206.

By these actions, the duration of the pressure cycle is shortened or lengthened. As the number of adsorbers of the separation unit 10 is constant in this method, the phase time is lengthened or shortened. This means that each of the pressure cycle phases is lengthened or shortened in the same fashion.

As an alternative to lengthening or shortening the phase time by acting on the duration of a cycle step, a dead time step may be added to the pressure cycle, during which step one or more adsorbers remain in the same state, for example by fluidically isolating the adsorber or adsorbers; or such a step may be eliminated from the pressure cycle. Such a step is not shown on FIGS. 3 and 4. However, such a method may also be used in addition to modification of the pressure cycle duration by acting on the duration of a cycle step.

It is understood that the phase time of the separation unit 10 may be modified by controlling at least one parameter of a gas flow supplied to an adsorber of the separation unit, and/or by controlling at least one parameter of the gas flow produced by an adsorber of the separation unit. At least one parameter of a gas flow transferred from one adsorber to another may in particular be controlled for this. In the described embodiments, the parameter or said parameters of the gas flow are selected from a flow rate of said gas flow and/or a flow duration of said flow, i.e. lengthening or shortening the flow over time. This may lead to integration of a step in the pressure cycle or elimination of a step from the cycle. Said step would, for example before its integration in the cycle, be considered as having a nil duration or a nil gas flow rate. The added step may be a dead time step.

To modify the rinsing flow rate, the control unit 13 may send a control signal to the flow rate adjustment device in order to increase or reduce the rinsing flow rate. The control unit 13 may for example order the three-way valve 9 to adjust the division of the first fraction between the product gas flow 35 and the rinsing flow 34.

With the aim of adaptation, for example to specifications imposed on the product yield R and purge rate P, the phase time and rinsing flow rate may be modified such that the first difference is made less than or equal to the first threshold S1, and/or the second difference made less than or equal to the second threshold S2. It is then possible to reach the pair of values of the parameters phase time TpX and rinsing flow rate QrX which will allow both the reference value C1 for product yield and the reference value C2 for purge rate to be reached or at least sufficiently nearly reached.

Various methods are proposed for determining this pair of values of phase time TpX and rinsing flow rate QrX.

A first suitable method for determining the variations to be made to the phase time and rinsing fluid flow rate is use by the control unit of a database comprising a plurality of operating points 1; 2; . . . ; N of the separation unit, each point 1; 2; . . . ; N containing the supply conditions (flow rate, composition, pressure, temperature) and in particular the phase time Tp1; Tp2; . . . ; TpN, the rinsing flow rate Qr1; Qr2; . . . ; QrN, the first component extraction yield (here the product yield R1; R2; . . . ; RN) and the second component extraction yield (here the purge rate P1; P2; . . . ; PN).

Thus the separation method may comprise a step 400 of recording in a database points 1; 2; . . . ; N of stabilized operation of the separation unit 10, the operating points corresponding in particular to pairs of phase time duration and rinsing flow rate value Tp1, Qr1; Tp2, Qr2, . . . ; TpN, QrN, each pair being associated with a product yield value R1; R2; . . . ; RN and a purge rate value P1; P2; . . . ; PN of the separation unit 10. This recording step may be performed continuously or periodically. In particular, the operating points 1; 2; . . . ; N are determined by simulating operation of the separation unit 10, and then recorded in the database. Simulation software performs series of digital calculations until a stable converged solution is found for a given series of input parameters. The stimulation software means software which dynamically simulates the adsorption processes. Such a procedure allows provision of a large database from the time of first use of the separation unit 10.

Simulation is performed for example by fixing a series of input parameters, including a nominal flow rate for supply of feedstock gas 30, a nominal composition of the feedstock gas 30, steps of the pressure cycle, a nominal phase time and/or pressures at the step end.

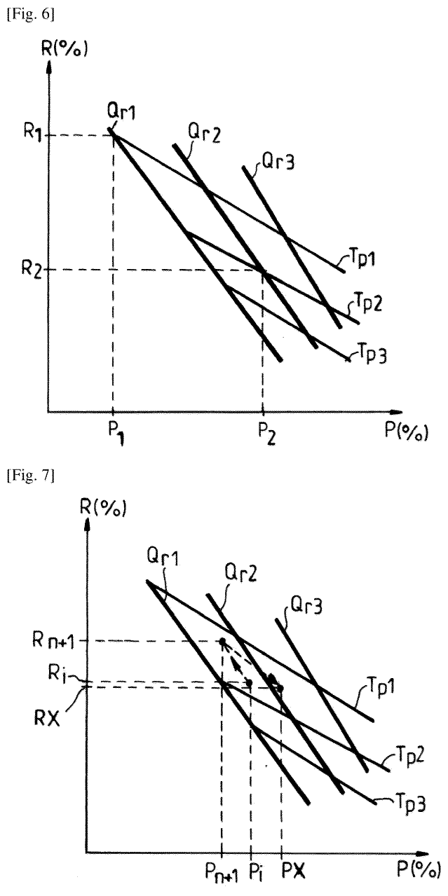

FIG. 6 shows an example of determination of stabilized operating points: the simulation comprises a first calculation step during which a phase time duration Tp1 is fixed and a rinsing flow rate value modified so as to obtain a correlation between the first component extraction yield (in particular the product yield) and the second component extraction yield (in particular the purge rate) as a function of the rinsing flow rate, for said fixed phase time duration Tp1. The first calculation step may be repeated for a new fixed phase time duration Tp2; Tp3 different from the preceding one, so as to obtain a new correlation. In particular, the fixed phase time duration Tp1; Tp2; Tp3 is calculated as a percentage of the nominal phase time. The simulation also comprises a second calculation step, during which a rinsing flow rate value Qr1 is fixed and a phase time duration modified so as to obtain a correlation between the first component extraction yield (in particular the product yield) and the second component extraction yield (in particular the purge rate) as a function of the phase time duration, for said fixed rinsing flow rate value Qr1. The second calculation step is repeated for a new fixed rinsing flow rate value Qr2; Qr3 different from the preceding one, so as to obtain a new correlation.

The second calculation step may also take place before the first calculation step. The first and/or the second calculation step may use an interpolation method for determining the correlations.

Each correlation allows a corresponding curve to be traced on FIG. 6. The intersection between the curve with iso-duration of phase time Tp1; Tp2; Tp3 and a curve with iso-value of rinsing flow rate Qr1; Qr2; Qr3 corresponds to an operating point 1; 2; 3 “first component extraction yield” versus “second component extraction yield”. For each recorded operating point 1; 2; 3, with fixed phase time durations and fixed rinsing flow rates, this therefore gives a pair of values “phase time duration” and “rinsing flow rate value” Tp1, Qr1; Tp2, Qr2; Tp3, Qr3 allowing achievement of the desired product yield R1; R2; R3 and purge rate P1; P2; P3 for the separation unit 10. The simulation thus allows determination of a given number of operating points which are recorded in the database.

The operating points 1; 2; . . . ; N lie in particular within a predetermined performance range of the unit. In particular, the phase time durations Tp1; Tp2; . . . ; TpN and rinsing flow rate values Qr1; Qr2; . . . ; QrN correspond to operating points lying within the ranges of phase time duration and rinsing flow rate defined by the dimensioning of the unit.

The product yield value Ri is thus determined in step 301 and the purge rate value Pi is determined in step 302. The first difference between the product yield Ri and the first reference value C1, and the second difference between the purge rate Pi and the second reference value C2, are calculated in step 303. The first difference is compared to the first threshold S1, and the second difference is compared to the second threshold S2.

If the first difference is less than or equal to the first threshold S1, and the second difference less than or equal to the second threshold S2, the method is terminated.

If the first difference is greater than the first threshold S1, and/or if the second difference is greater than the second threshold S2, the method proceeds to step 401 of reading from the database, from the recorded pairs of phase time durations and rinsing flow rate values TP1, Qr1; Tp2, Qr2, . . . , TpN, QrN, a phase time duration TpX and a rinsing flow rate value QrX which will allow the first difference to be brought below the first threshold S1 or the value of the first threshold S1, and/or the second difference to be brought below the second threshold S2 or the value of the second threshold S2.

Once the pair of values for phase time TpX and rinsing flow rate QrX is determined, the method proceeds to step 304: the phase time duration Tpi is changed into the phase time duration TpX read from the database, and the rinsing flow rate value Qri is changed into the rinsing flow rate value QrX read from the database. The separation unit 10 then operates with a product yield and purge rate such that the first difference is less than or equal to the first threshold S1 and the second difference is less than or equal to the second threshold S2.

The values of the phase time and rinsing flow rate parameters which will allow both the reference value C1 for product yield and the reference value C2 for purge rate to be reached or at least sufficiently nearly reached, may thus be determined by iteration.

According to this second method, steps 301; 302; 303 and 304 are repeated with, for step 304, a modification of the last phase time duration Tpn reached by the separation unit 10 during the preceding iteration into a new phase time duration Tpn+1, and modification of the last rinsing flow rate value Qrn reached by the separation unit 10 during the preceding iteration into a new rinsing flow rate value Qrn+1, until the first difference is less than or equal to the first threshold S1 and/or the second difference is less than or equal to the second threshold S2.

As shown on FIG. 7, the modification of the phase time and rinsing fluid flow rate may be implemented in a first time by iterations via the duration of the phase time, with a constant rinsing flow rate value, then in a second time by iterations via the rinsing flow rate value, with a constant phase time duration. Such a sequence may in particular be repeated. In a reversed implementation (not shown), the modification of the phase time and rinsing fluid flow rate may also be implemented in a first time by iterations via the rinsing flow rate value, with a constant phase time duration, then in a second time by iterations via the the phase time duration, with a constant rinsing flow rate value. Such a sequence may also be repeated.

Steps 301; 302; 303 and 304 are repeated in addition to modification of the phase time duration and rinsing flow rate value by reading from a database in step 401, in particular after this modification by reading from a database. Said last phase time duration Tpn may for example have been reached by the separation unit 10 using the method of reading from a database, and said first rinsing flow rate value Qrn similarly. The method of iterations may also be implemented as an alternative to the method of reading from a database. Modification of the phase time and rinsing fluid flow rate by the iteration method is particularly advantageous when a particular threshold of differences is not exceeded. Modification of the phase time duration and rinsing fluid flow rate value by iterations is particularly advantageous for more finely adjusting the extraction yields following modification of the phase time duration and rinsing fluid flow rate value by reading from the database. Switching from the method of reading from a database to the method of iterations (or vice versa) may take place as a function of the value of the first difference and/or the value of the second difference.

Steps 301; 302; 303 and 304 may also be repeated via a cause/effect learning process in which the effects of an initial modification of the phase time duration and rinsing flow rate value are determined, then stored in a memory, said effects being taken into account on a following modification of the phase time duration and rinsing flow rate value.

Such a learning process also allows determination of the order of modifications of phase time/rinsing flow rate in the case where the modifications are performed successively, so that on a change in reference values, the yield always remains above an initial yield considered a minimum. For example, in an operation according to the curves in FIG. 7, in order to increase the purge rate P while retaining the product yield R and never allow this to fall below its initial value during the transitional phases, the method would lead to firstly shortening the phase time and then to increasing the rinsing flow rate.

When the uncertainties are negligible, the phase time and rinsing flow rate are modified such that the determined product yield R reaches the first reference value C1, and/or the determined purge rate P reaches the second reference value C2. In this case, a nil value may be assigned to the first threshold S1 and second threshold S2. Thus in the case of a difference between the determined product yield R and the first reference value C, and/or a difference between the determined purge rate P and the second reference value C2, the phase time and the rinsing flow rate are modified such that the determined product yield R reaches the first reference value C1 and/or the determined purge rate P reaches the second reference value C2.

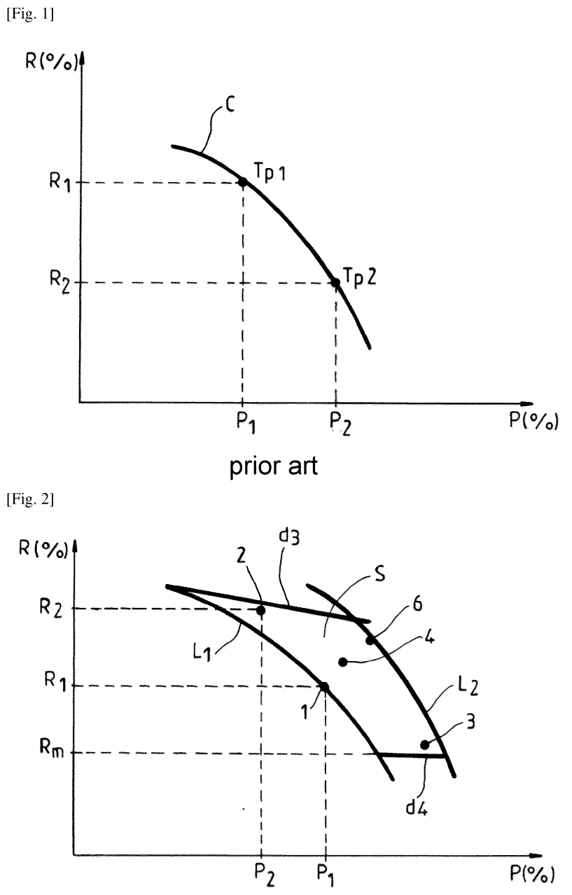

Controlling the two parameters of rinsing flow rate and phase time therefore causes variation in the extraction yields (product yield R and purge rate P), and thus allows greater operating flexibility for the first component and second component extraction yields in comparison with separation units of the prior art. This flexibility may be represented schematically not by a curve, as in FIG. 1, but by a band or more generally an operating area S (R, P) in the diagram “product extraction yield” versus “purge rate”, at least part of which will lie beyond the limit curve which could be achieved by a standard PSA. An example is shown in FIG. 2.

For example, if the supply flow rate of the feedstock gas 30 varies, as a first approximation, the phase time should be varied inversely proportionally to the supply flow rate and the rinsing flow rate proportionally to this same flow rate, in order to retain the same performance. If necessary, it is possible to refine this by means of simulations, which could take into account generally very secondary effects linked to the kinetics of adsorption and the load losses of the unit.

FIG. 2 shows, next to the conventional curve L1 of the yields of a PSA, the operating area S (R, P) containing the operating points 1, 2, 3, 4 which the separation unit 10 could achieve during its operation, taking into account the expected changes. With the exception of point 1, all other points cannot be reached by a standard PSA.

The target series of operating points 1 to N is determined at the time of definition of the separation unit 10, as a function of the expected changes in the supply conditions (for example, it is known how the composition of a discharge gas or a natural gas source varies over time), the required performance (for example, reduction in atmospheric discharges, increase in capacity of a downstream unit, necessity for periodic purging of the recycling circuit). The separation unit 10 is then dimensioned such that the operating area S of possible points (R, P) contains the selected operating points 1 to N. In practice, all points of the area correspond to a possible operation.

More precisely, in the case of FIG. 2, the operating area S is limited by the curve L1 which corresponds to operation of the unit with a nil rinsing fluid flow rate, i.e. with a standard PSA cycle, and by curve L2 which in contrast corresponds to the maximum rinsing fluid flow rate selected at the time of design. This maximum flow rate is decisive for the dimensions of the majority of equipment (adsorbers, adsorbent mass, machines etc.). The upper limit for this unit, here similar to the gradient d3, corresponds to the minimum phase time duration selected. This minimum value is fixed by taking into account, generally from the time of design, characteristics such as the adsorption kinetics, the duration of elementary steps, the dimensioning of valves, the speed of fluids, and in particular the risks of attrition of the adsorbent. Finally, the lower limit—here similar to the gradient d4—is fixed by the minimum extraction yield threshold Rm which is acceptable (for economic reasons or for example to guarantee satisfactory operation of a downstream unit).

Of the points selected for determining the operating area S, and hence the dimensioning of the unit, we distinguish point 1 which corresponds to the first nominal operating mode of the separation unit 10 after start-up. According to another embodiment, point 1 corresponds to the limit point which is acceptable in the case of non-operational rinsing (maintenance of a compressor for example). This point corresponds to operation of the unit with the product yield value R1 and purge rate P1. We can also distinguish point 2, which tends to favour the useful product yield to the detriment of the purge rate, or conversely point 3 which favours the purge. These two cases may also be extreme operations linked to a recycling loop in which the content of inert gas (here the poorly adsorbable fraction) varies as a function of time for reasons external to the separation unit. Points 4 and 5 correspond to performance targets expected in the future. In practice, all points of the area S can be reached by the separation unit and correspond to a single pair of “phase time, rinsing flow rate” (not shown on FIG. 2).

A rinsing ratio in the method according to the invention typically lies between 0.05 and 0.65, or even between 0.05 and 0.5. Thanks to the method according to the invention, it is possible to obtain an operating flexibility with low rinsing ratios such that the unit 10 remains effective and competitive, in contrast to methods in which high yields and high purity levels are desired.

The method according to the invention has several applications.

The separation method is for example used in a recycling loop in order to capture carbon monoxide from the fumes of a blast furnace and recycle these as a reducing agent into said blast furnace. The fumes constitute the feedstock gas 30 and comprise a mixture of carbon monoxide and nitrogen, wherein the first fraction 31 is enriched in carbon monoxide and the second fraction 32 is enriched in nitrogen. The fumes are for example firstly treated in a carbon dioxide capture unit. Carbon monoxide is a useful gas similar to a product, and is extracted from the fumes by the separation unit 10 with an adjustable product yield R. Nitrogen is a residual gas similar to a purge, and is extracted from the fumes by the separation unit 10 with an also adjustable purge rate P. Thanks to the method according to the invention, it is possible to obtain the desired carbon monoxide extraction yield and the desired nitrogen purge rate. Thus precise specifications such as the proportion of nitrogen and carbon monoxide may be observed for the first gaseous fraction 31 recycled into the blast furnace. In steel-making processes, reducing the quantity of nitrogen in a flow originating from fumes and recycled into a blast furnace allows emission of less carbon dioxide at the outlet from the blast furnace and hence a reduction in the size of the carbon dioxide capture unit.

The separation method may also be used to capture carbon dioxide. The feedstock gas 30 comprises a mixture of carbon dioxide and nitrogen, the first fraction 31 being enriched in carbon dioxide, the second fraction 32 being enriched in nitrogen, carbon dioxide constituting the first component and nitrogen constituting the second component. It may in fact be necessary for environmental reasons to increase the CO2 capture rate over time for a supply of feedstock gas 30 with a constant flow rate and composition. It may for example be necessary to switch from an extraction yield of 50% to 55%, and then 60% while always purging the same quantity of nitrogen.

The separation method may also be used for purifying a feedstock gas 30 comprising a mixture of methane and nitrogen. The first fraction 31 is enriched in methane, the second fraction 32 is enriched in nitrogen, methane constituting the product and nitrogen constituting the purge. It is then possible to separate nitrogen from a biogas as a step in processing the biogas, so as to make it compatible with the specifications of a natural gas distribution network. More generally, any gas flow containing methane and compounds which are less adsorbable than methane may be treated similarly.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-14. (canceled)

15. A method for separating a feedstock gas by pressure swing adsorption, wherein a separation unit is supplied with the feedstock gas and produces a first gaseous fraction enriched in a first component and a second gaseous fraction enriched in a second component, the first component being more adsorbable than the second component, the separation unit comprising a plurality of adsorbers, said adsorbers being subjected to a pressure cycle featuring a high pressure and a low pressure, the pressure cycle comprising a plurality of steps including at least one adsorption step and at least one rinsing step in which a rinsing fluid enriched in the first component circulates through at least one adsorber so as to expel at least a part of the second component from said adsorber, the pressure cycle having a phase time corresponding to a duration of the pressure cycle divided by the number of adsorbers, the method comprising the following steps:
a) determining a first component extraction yield value defined by the ratio of the quantity of first component in the first fraction produced over the quantity of first component in the feedstock gas supplied to the separation unit,
b) determining a second component extraction yield value defined by the ratio of the quantity of second component in the second fraction produced over the quantity of second component in the feedstock gas supplied to the separation unit,
c) determining a first difference between the first component extraction yield value determined in step a) and a first reference value relating to the first component extraction yield, and of a second difference between the second component extraction yield value determined in step b) and a second reference value relating to the second component extraction yield,
d) wherein, if the first difference is greater than a first predetermined threshold and/or the second difference is greater than a second predetermined threshold, modification of the phase time and modification of a rinsing fluid flow rate, called the rinsing flow rate, so as to reduce the first difference and/or the second difference.

16. The method of claim 15, wherein the first reference value expressed as a yield percentage lies between 25 and 90% and the second reference value expressed as a yield percentage lies between 20 and 90%.

17. The method of claim 16, wherein a part of the first fraction is used as product gas and another part is utilized as rinsing fluid, the ratio of the rinsing flow rate to the sum of the rinsing flow rate and a product gas flow rate being between 0.05 and 0.65.

18. The method of claim 16, wherein the phase time is modified by controlling at least one parameter of a gas flow supplying an adsorber of the separation unit and/or at least one parameter of a gas flow produced by an adsorber of the separation unit.

19. The method of claim 18, wherein said at least one parameter is selected from the flow rate and/or the flow duration.

20. The method of claim 18, wherein the phase time is modified by shifting in time a start and/or an end of supply of the gas flow to at least one adsorber.

21. The method of claim 18, wherein the phase time is modified by shifting in time a start and/or an end of production of the gas flow by at least one adsorber.

22. The method of claim 18, wherein a flow rate of a gas flow transferred from one adsorber to another is regulated so as to accelerate or decelerate a gas transfer between said adsorbers.

23. The method of claim 15, further comprising the following steps:
i) recording in a database points of stabilized operation of the separation unit, the operating points corresponding to pairs of phase time duration and rinsing flow rate value, each pair being associated with a first component extraction yield value and a second component extraction yield value of the separation unit,
ii) if the first difference is greater than the first threshold and/or the second difference is greater than the second threshold, reading from the database a phase time duration and a rinsing flow rate value allowing the first difference to be made less than or equal to the first threshold and/or the second difference to be made less than or equal to the second threshold, then modification of the phase time into the phase time duration read from the database and modification of the rinsing flow rate into the rinsing flow rate value read from the database.

24. The method of claim 15, wherein steps a), b), c) and d) are repeated until the first difference is less than or equal to the first threshold and/or the second difference is less than or equal to the second threshold, with, for step d), a modification of the last phase time duration into a new phase time duration and a modification of the last rinsing flow rate value into a new rinsing flow rate value.

25. The method of claim 15, wherein the first gaseous fraction is recycled into the blast furnace as a reducing agent, wherein the feedstock gas comprises a mixture of carbon monoxide and nitrogen, the first gaseous fraction is enriched in carbon monoxide and the second fraction is enriched in nitrogen, carbon monoxide constituting the first component and nitrogen constituting the second component.

26. The method of claim 15, wherein the feedstock gas comprises a mixture of carbon dioxide and nitrogen, the first fraction being enriched in carbon dioxide, the second fraction being enriched in nitrogen, carbon dioxide constituting the first component and nitrogen constituting the second component.

27. The method of claim 15, wherein the feedstock gas comprises a mixture of methane and nitrogen, the first fraction being enriched in methane, the second fraction being enriched in nitrogen, methane constituting the first component and nitrogen constituting the second component.

28. A unit for separating a feedstock gas by pressure swing adsorption for production of a first gaseous fraction enriched in a first component and a second gaseous fraction enriched in a second component, the first component being more adsorbable than the second component, the separation unit comprising a plurality of adsorbers configured to be subjected to a pressure cycle featuring a high pressure and a low pressure, the cycle comprising a plurality of steps including at least one adsorption step and a rinsing step during which a rinsing fluid enriched in the first component circulates through at least one adsorber so as to expel at least a part of the second component from said adsorber, the pressure cycle having a phase time corresponding to the duration of the pressure cycle divided by the number of adsorbers, wherein the separation unit comprises:
a flow control system configured to modify the phase time by controlling at least one parameter of a gas flow supplied to an adsorber of the separation unit and/or at least one parameter of a gas flow produced by an adsorber of the separation unit, in particular at least one parameter of a gas flow transferred from one adsorber to another,
a flow adjustment device configured to modify a rinsing fluid flow rate,
a control unit and communication means between the control unit, the flow control system and the flow adjustment device, the control unit being configured to implement the method as claimed in any of the preceding claims.
